(19) United States
(12) Patent Application Publication
(10) Pub. No.: US 2017/0242638 A1
(43) Pub. Date: Aug. 24, 2017

(54) SYSTEM AND METHOD FOR CONTROL OF PRINTED DOCUMENTS BASED ON CLASSIFICATION

(71) Applicant: DELL PRODUCTS L.P., Round Rock, TX (US)

(72) Inventors: Jake Seigel, Halifax (CA); Sohail Ali, Halifax (CA)

(21) Appl. No.: 15/048,563

(22) Filed: Feb. 19, 2016

(51) Int. Cl. G06F 3/12

(52) U.S. Cl. CPC G06F 3/1222; G06F 3/1238; G06F 3/1294; G06F 3/1288

(57) ABSTRACT

A system for controlling printing of classified documents, comprising a print server having a processor and software operating on the processor, the software configured to receive data for printing and associated print control data and to format the data for printing according to the associated print control data. A print agent having software configured to operate on the processor of the print server, the print agent software configured to interface with the print server software to obtain classification data associated with the data for printing and to determine whether the classification data prevents the data for printing from being printed.

### TECHNICAL FIELD

The present disclosure relates generally to printer control systems, and more specifically to controlling the availability of printing facilities for documents based on classification of the document.

### BACKGROUND OF THE INVENTION

Organizations might create documents containing sensitive information which if leaked, can violate legal obligations of the organization. Organizations typically secure these document from unauthorized access using access and identity management software, and solutions even exist to prevent them from emailing the documents outside of the company, however there is still a venue that is unprotected: printed documents.

### SUMMARY OF THE INVENTION

A system for controlling printing of classified documents is disclosed that includes a print server having a processor and software operating on the processor that is configured to receive data for printing and associated print control data and to format the data for printing according to the associated print control data. A print agent has software configured to operate on the processor of the print server, to interface with the print server software to obtain classification data associated with the data for printing and to determine whether the classification data prevents the data for printing from being printed.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for controlling printed documents based on classification data, in accordance with an exemplary embodiment of the present disclosure; and

FIG. 2 is a diagram of an algorithm for controlling printed documents based on classification data, in accordance with an exemplary embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

The present disclosure is related to systems and processes that merge the concept of resource ownership with data classification, and includes performing a scan of all resources across an enterprise, in order to classify those resources using pre-built taxonomies for the purpose of allowing or denying printing. Manual classification of documents, such as by using systems and methods available from Titus, Inc. of Ontario, Canada or other suitable systems or methods, is also becoming a normal practice at organizations as well. This present disclosure can utilize data from those or other systems and processes to make document and user specific determinations of whether to permit or block a print request.

One aspect of the present disclosure is a printing agent that can be deployed within a printing server or in other suitable environments, and which can analyze incoming print jobs and determine whether or not to take action, such as to block the print job, notify an operator, log the activity or to take other suitable actions. As a preliminary matter, printing events can be collected and sent to an auditing system, where the printing events can be connected to a user's identity for auditing/compliance purposes. The agent can be configured to reject the print job, alert an operator or to take other suitable actions in response to a request to print documents that have been classified with certain taxonomies. The agent can thus audit print jobs based on resource classification, and can reject the job depending on the contents of the resource.

In one exemplary embodiment, if a document is manually classified, an administrator can be alerted, to determine whether the classification was made in an attempt to circumvent document security protocols. In another exemplary embodiment, a document can be automatically classified as having customer personal information, and can be rejected from a print queue until an authorized party can validate the request.

In another exemplary embodiment, certain groups or users can be given permission to print documents based on predetermined factors, to provide a fine-grained print permission system based on document classification, such as:
The group or user can only print documents having a risk level that is equal to or lower than a predetermined risk level
The group or user is not allowed to print documents that have been classified with specific taxonomies
The group or user is only allowed to print certain levels of the taxonomy (such as linear ordered taxonomies)

In another exemplary embodiment, an agent can be deployed on a print server that can interject itself into a document print pipeline, so as to be able to read the data from the document and to determine whether the document should be rejected, such as by using a text extraction module to change the document to a raw textual format, by sending the document to a classification server for classification processing, or in other suitable manners.

The print agent can also or alternatively connect to a classification server, which can accept the document contents for classification, and can process the document and return the results in real time to the printer agent.

The print agent can be configured to use the classification results sent by the classification server, as well as any classification data stamped on the document or otherwise associated with the document, in order to facilitate the data processing and to make an automated decision. The automated decision can also implicate a business rule engine that factors in identified groups and other identity metadata. The business rule engine can also specify if there are additional events that should be initiated in response to the print request, such as sending an audit event to a change auditor in specific situations and as a function of metadata transmitted with the print job, for all situations and regardless of metadata transmitted with the print request, for random situations or in other suitable manners. The print agent can be configured to make a decision and to allow the document to be printed, to reject the print job, to alert a user via email or text message, to provide other suitable alerts or to perform other suitable actions. The workflow can also or alternatively be configured to obtain permission to print the document from an administrator or other provisioned party.

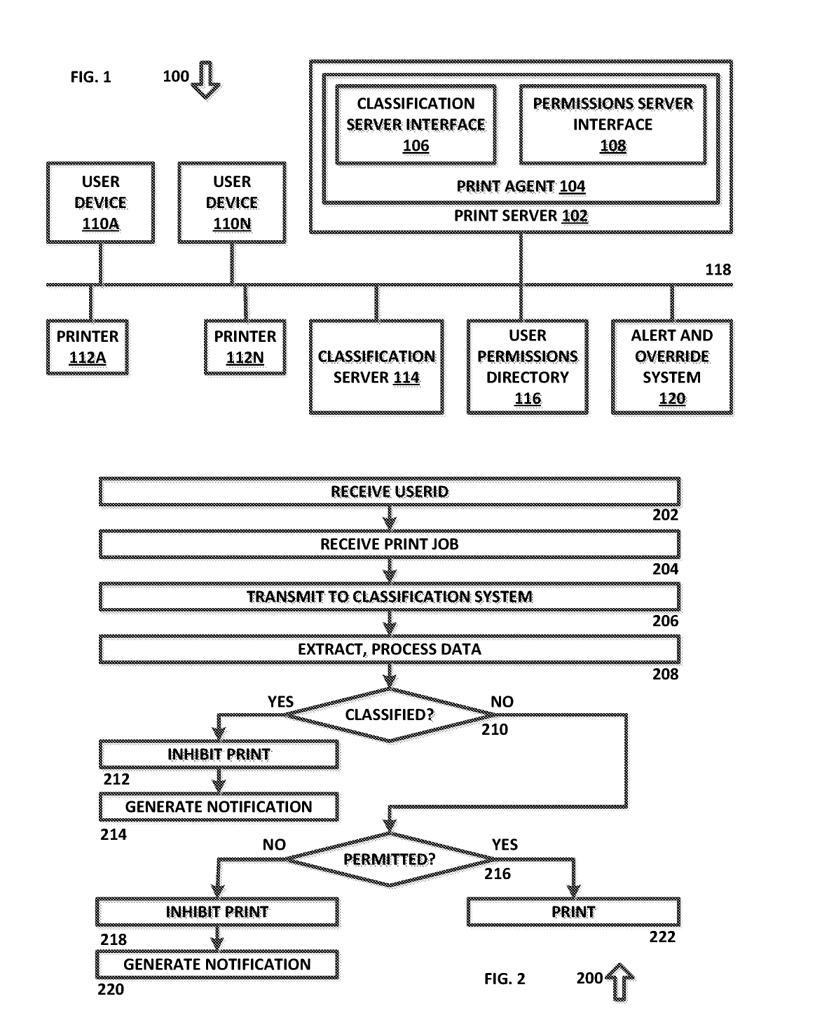

FIG. 1 is a diagram of a system 100 for controlling printed documents based on classification data, in accordance with an exemplary embodiment of the present disclosure. System 100 includes print server 102, print agent 104, classification server interface 106, permissions server interface 108, user devices 110A through 110N, printers 112A through 112N, classification server 114, user permissions directory 116, alert and override system 120 and communications media 118, each of which can be implemented in hardware or a suitable combination of hardware and software.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

Print server 102 receives print requests from user devices 110A through 110N and formats the print requests for printing at one or more of printers 112A through 112N. In one exemplary embodiment, print server 102 can be an enterprise print server that is used by multiple users in a single physical location, such as a floor of a building, and which provides print services for multiple printers in that location from multiple user devices in that location, or can be used for other suitable applications.

Print agent 104 operates on print server 102 and analyzes incoming print jobs to determine whether or not to take action, such as to block the print job, notify an operator, log the activity or to take other suitable actions. In one exemplary embodiment, print agent 104 can analyze metadata associated with a print job, such as data that identifies the document, the user that is requesting the document to be printed, or other suitable data, and can interface with additional systems and devices, such as classification server 114, user permissions directory 116, alert and override system 120 or other suitable systems as a function of that data, either by comparing the data to predetermined metadata fields associated with that document or the user that is requesting the print processing, by extracting data from the document and processing the extracted data to identify predetermined data fields, to process the data in accordance with one or more predetermined algorithms or in other suitable manners. Print agent 104 can also or alternatively be deployed in conjunction with user devices 110A through 110N, printers 112A through 112N, classification server 114, user permissions directory 116, alert and override system 120, other suitable systems, other suitable devices or a suitable combination of systems and devices.

Classification server interface 106 receives data associated with a document and a print request and interfaces with classification server 114 or other suitable systems to generate print/do not print control data. In one exemplary embodiment, classification server interface 106 can receive metadata associated with a document and determine whether classification data associated with the document is current, such as by comparing a time field associated with the generation of the classification data to a time field associated with a most recent editing of the document, a security level field associated with the document to a security level field associated with a user, a printer or an organization, by comparing extracted text data from metadata or the document to be printed to a database of text strings that have associated printing restriction controls or data, or in other suitable manners. In this exemplary embodiment, if the document has been edited since it was last classified, then the document can be sent to classification server 114 for reclassification. In another exemplary embodiment, classification server interface 106 can transmit every document to classification server 114 for processing, and can generate metadata associated with the document that is used to track the document, the party requesting printing, the device from which the printing request was submitted, the device where the printing request will be executed, or other suitable data, to determine whether the document has been processed in response to a request when it is returned, or to perform other suitable processing.

Permissions server interface 108 receives data associated with a user requesting the printing of a document, data associated with the document and a print request, and interfaces with user permissions directory 116 or other suitable systems to generate print/do not print control data. In one exemplary embodiment, permissions server interface 108 can receive user identification data fields, user organization data fields, user location data fields, metadata associated with a document and other suitable data, and can transmit the user data and metadata to user permissions directory 116 to determine whether the user is authorized to print the document. In another exemplary embodiment, permission server interface 108 can transmit the document to be printed to user permissions directory 116 for processing, can generate metadata data fields associated with the document that are used to track the document, can determine whether the document has been processed in response to a request when it is returned, or can perform other suitable processing.

User devices 110A through 110N can be desktop computers, laptop computers, tablet computers, smartphones, virtual devices, multifunction peripheral controllers, or other suitable devices that have the capability to schedule a print request using a print server. In one exemplary embodiment, user devices 110A through 110N can be assigned to print server 102 for all printing functions, can access print server 102 on demand or can otherwise interface with print server 102 to submit documents for printing.

Printers 112A through 112N can be workstation printers, network printers or other suitable printers that can receive printing requests directly from user devices 110A through 110N (such as through a wireless connection), over network 118 or in other suitable manners, and which can interface with print server 102 for subsequent processing of print requests.

Classification server 114 receives document data and generates classification data as a function of document metadata, data extracted from the document or other suitable data. In one exemplary embodiment, classification server 114 can include a taxonomy of classification terms, such as terms that have been identified as being associated with documents that should not be printed, terms associated with predetermined user organizations or other suitable data, and can return classification data to a print agent that is used to determine whether the document should be printed, such as to generate a go/no-go decision. The taxonomy can include weighting factors associated with each term, sets of associated terms that have a functional relationship to the decision on whether to print, functions associated with terms and other suitable data. For example, if a user is associated with an organization, the taxonomy can identify document terms that are in documents that are permitted to be printed if the document creation date is between a first date and a second date, but where the documents are not permitted to be printed if the document creation date is between the second date and a third date. Likewise, if a user is associated with a location, the taxonomy can identify document terms that are in documents that are permitted to be printed if the printer device location is contained in a set of allowable locations, but where the documents are not permitted to be printed if the printer device location is not contained in the set of allowable locations. Classification server 114 can return print authorization data to initiate printing, warning data to the user to stop trying to print the document, alert data to an administrator or security personnel, or other suitable data. Other suitable functions can also or alternatively be implemented.

User permissions directory 116 can receive print request data that includes document data and metadata, user identification data, organization data associated with the user, permission data associated with the user or other suitable data and can generate print request authorization data as a function of directory data and directory functions. In one exemplary embodiment, a user can request to print a document, and the request can be transmitted to user permissions directory 116 over network 118 in a plurality of data packets. The request can include associated data fields, such as a user name data field, a user organization data field, a user affiliation data field and other suitable data. User permissions directory 116 can determine whether the user name is on a permission list for a document, whether the user is associated with an organization that is on a permission list for a document, whether the user is authorized to print the document based on the document content, whether the user is in an organizational structure that allows the user to print the document, whether the user is in a location that allows the user to print a document, whether the printer is in a location that allows the user to print a document or if other permission-level access can be granted to allow the user to print a document. User permissions directory 116 can return print authorization data to initiate printing, warning data to the user to stop trying to print the document, alert data to an administrator or security personnel, or other suitable data. Other suitable functions can also or alternatively be implemented.

Alert and override system 120 receives printer authorization denial data and generates an alert to an administrator or security personnel, an override prompt to a manager or administrator, or other suitable data. In one exemplary embodiment, alert and override system 120 can generate an alert when a user makes a single attempt to print a document based on a document, when a user makes repeated attempts to print a document after receiving warnings, if a user attempts to manually reclassify a document to defeat print protection, if a user attempts to redirect a print job to a different printer in order to defeat print protection, if the user attempts to take a screen capture of the document after being prevented from printing the document, or in other suitable situations. In another exemplary embodiment, an override screen can be generated locally or at a user-selected supervisor terminal, at an administrator terminal or at other suitable locations, based on a difference between a user profile and a document profile or in response to other suitable conditions.

Communications media 118 can be an enterprise electrical network, an enterprise optical network, a wireless network, a public network, an ad hoc network, other suitable networks or a suitable combination of networks. Communications media 118 can include firewalls, security systems, user access systems, data storage devices, data file servers, application servers and other suitable devices, systems and components.

In operation, system 100 allows a user to access documents for printing, and determines whether the user has appropriate access rights to print the document, such as to prevent unauthorized users from printing documents, to protect against improper copying of copyrighted works, to prevent printing of sensitive personal or corporate data, to enforce document confidentiality controls or for other suitable purposes. System 100 allows access controls to be set as a function of a user identifier, an organization affiliation of a user, an operational affiliation of a user, or in other suitable manners, and further provides for generating alerts and obtaining overrides.

FIG. 2 is a diagram of an algorithm 200 for controlling printed documents based on classification data, in accordance with an exemplary embodiment of the present disclosure. Algorithm 200 can be implemented in hardware or a suitable combination of hardware and software.

Algorithm 200 begins at 202, where a user identifier is received. In one exemplary embodiment, the user identifier can be received as part of a user print command that is transmitted when a user submits a print job. In another exemplary embodiment, the user identification can be received in response to a query from a print agent to a user access control system, or other suitable processes can also or alternatively be used. The algorithm then proceeds to 204.

At 204, a print job is received, such as by receiving a file containing data for printing and associated file metadata, by receiving a document identifier for a document management system and by requesting document data from the document management system that corresponds to the document identifier or in other suitable manners. The algorithm then proceeds to 206.

At 206, the document data is transmitted to a classification system. In one exemplary embodiment, the document file can be transmitted to the classification system for text data extraction and processing. In another exemplary embodiment, text data can be extracted from the document, and the text data can be stored in a file or other suitable data structures and transmitted to the classification system in a data structure other than the original printer file. The algorithm then proceeds to 208.

At 208, data is extracted and processed from the print file, such as by performing optical character recognition on image data, by extracting formatted text strings associated with a print file from an associated file or other suitable data structures, by extracting document metadata or in other suitable manners. The algorithm then proceeds to 210.

At 210, it is determined whether the data is classified. In one exemplary embodiment, the document data can be compared to a taxonomy of classified document data terms, text data strings and other suitable document data, and a classification score can be generated based on a number of classified document terms, a scoring algorithm or in other suitable manners. If it is determined that the data is classified and that no permissions are available to override the classification, the algorithm proceeds to 212, where printing is inhibited. The algorithm then proceeds to 214, where a notification is generated, and the algorithm terminates.

If it is determined at 210 that the data is not classified, or that it is classified but that there may be permission-based overrides, the algorithm proceeds to 216, where it is determined whether a permission-based override is available. In one exemplary embodiment, a permission-based override can be determined from a user permissions directory, such as one that identifies document print permissions associated with individual users for specific documents, with individual users for classes of documents, with individual users based on the content of documents, with user-affiliated organizations for specific documents, with user-affiliated organizations for classes of documents, with user-affiliated organizations based on the content of documents, based on real-time permission granted by a supervisor or administrator, or other suitable permission-based overrides. If it is determined that a permission-based override is available, the algorithm proceeds to 222 and the document is printed, such as by generating a print command, generating a command to terminate an inhibit print control or in other suitable manners.

If it is determined at 216 that no print permissions exist, then the algorithm proceeds to 218, where printing is inhibited, and to 220 where a notification is generated. The algorithm then terminates.

In operation, algorithm 200 allows the printing of documents to be controlled based on a security classification, such as to prevent the printing of confidential documents, documents containing personal information, documents that are subject to copyright restrictions or other suitable documents. Algorithm 200 allows users that have suitable permissions to override such restrictions, such as by determining whether the user has permission to print the document, a class of documents associated with the document, or in other suitable manners.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A system for controlling printing of classified documents, comprising:
a print server having a processor and software operating on the processor, the print server software configured to receive data for printing, an associated document identifier data, and associated print control data and to format the data for printing according to the associated print control data;
a print agent having software operating on the processor of the print server, the print agent software interfaces with the print server software to obtain classification identifying classification of the data for printing using the document identifier and determines whether the classification data prevents the data for printing from being printed.

2. The system of claim 1 wherein the print agent software compiles a request data message and transmits the request data message to a classification server having a second processor and classification server software operating on the second processor, the classification server software receives the request data message and returns a classification data message containing classification data for the data for printing.

3. The system of claim 2 wherein the print agent software receives the classification data message and allows or prevents the data for print from being printed as a function of the classification data message.

4. The system of claim 2 wherein the print agent software receives the classification data message and allows the data for print to be printed by generating print inhibit override control data that is associated with the data for print.

5. The system of claim 1 wherein the print agent software compiles a request data message and transmits the request data message to a user permissions directory having a second processor and user permissions directory software operating on the second processor, the user permissions directory software receives the request data message and returns a user permissions data message containing user permissions data for the data for printing.

6. The system of claim 5 wherein the print agent software receives the user permissions data message and allows or prevents the data for print to be printed as a function of the user permissions data message.

7. The system of claim 1 wherein the print agent software compiles a request data message and transmits the request data message to a classification server having a second processor and classification server software operating on the second processor, the classification server software receives the request data message and returns a classification data message containing classification data for the data for printing, wherein the print agent software receives the classification data message and allows or prevents the data for print from being printed as a function of the classification data message, and wherein the print agent software receives the classification data message and allows the data for print to be printed by generating print inhibit override control data that is associated with the data for print.

8. A method for controlling printing of classified documents, comprising:
receiving data for printing, an associated document identifier data, and associated print control data at a print server;
formatting the data for printing with the print server according to the associated print control data;
interfacing with the print server software using a print agent to obtain classification data identifying classification of the data for printing using the document identifier; and
determining whether the classification data prevents the data for printing from being printed.

9. The method of claim 8 further comprising compiling a request data message with the print agent.

10. The method of claim 9 further comprising transmitting the request data message from the print agent to a classification server.

11. The method of claim 10 further comprising receiving a classification data message from the classification server at the print agent, the classification data message containing classification data for the data for printing.

12. The method of claim 9 further comprising allowing or preventing the data for print from being printed with the print agent as a function of the classification data message.

13. The method of claim 9 further comprising allowing the data for print to be printed with the print agent by generating print inhibit override control data that is associated with the data for print.

14. The method of claim 9 further comprising transmitting the request data message from the print agent to a user permissions directory.

15. The method of claim 14 further comprising receiving a user permission data message from the user permission directory at the print agent, the user permission data message containing user permission data for the data for printing.

16. The method of claim 15 further comprising allowing or preventing the data for print from being printed with the print agent as a function of the user permission data message.

17. A method for controlling printing of classified documents, comprising:
receiving data for printing, an associated document identifier data, and associated print control data at a print server;
formatting the data for printing with the print server according to the associated print control data;
interfacing with the print server software using a print agent to obtain classification data identifying classification of the data for printing using the document identifier;
determining whether the classification data prevents the data for printing from being printed;
compiling a request data message with the print agent;
transmitting the request data message from the print agent to a classification server;
receiving a classification data message from the classification server at the print agent, the classification data message containing classification data for the data for printing;
allowing or preventing the data for print from being printed with the print agent as a function of the classification data message; and
allowing the data for print to be printed with the print agent by generating print inhibit override control data that is associated with the data for print.

18. The method of claim 17 further comprising transmitting the request data message from the print agent to a user permissions directory.

19. The method of claim 18 further comprising receiving a user permission data message from the user permission directory at the print agent, the user permission data message containing user permission data for the data for printing.

20. The method of claim 17 further comprising allowing or preventing the data for print from being printed with the print agent as a function of the user permission data message.
